(19) United States
(12) Patent Application Publication
(10) Pub. No.: US 2022/0104471 A1
(43) Pub. Date: Apr. 7, 2022

(54) Vibrating Disc Fishing Lure

(71) Applicant: Curt R. Reeff, Bismarck, ND (US)

(72) Inventor: Curt R. Reeff, Bismarck, ND (US)

(21) Appl. No.: 17/061,129

(22) Filed: Oct. 1, 2020

(51) Int. Cl. A01K 85/14

(52) U.S. Cl. CPC A01K 85/14

(57) ABSTRACT

A vibrating disc fishing lure for adding motion to live bait as it moves through the water. The vibrating disc fishing lure generally includes a leader with a fixed loop adapted for attachment to a fishing line, the leader also being attached to or including a fishhook. The lure also includes a disc on the leader positioned between the fixed loop and the fishhook, the disc having a flat front surface toward the fixed loop and a flat rear surface toward the fishhook, and having an opening that extends from the flat front surface to the flat rear surface, wherein the leader passes through the opening such that the disc is free to rotate and vibrate on the leader.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a vibrating disc fishing lure for creating vibration, flash and motion in live fishing bait.

### Related Art

Any discussion of the related art throughout the specification should in no way be considered as an admission that such related art is widely known or forms part of common general knowledge in the field.

Fishing lures for use with live bait usable for fishing are on the market, and have been for a number of years, but do not provide action or motion of the live bait. In other words, they are not designed to create action and flash for use with live bait, to make live bait more attractive to fish.

### SUMMARY

An example embodiment is directed to a vibrating disc fishing lure. The embodiments disclose a multi-directional live bait disc with “action” and flash. In use, the vibrating disc fishing lure typically rotates in one direction for three or four rotations, then pauses and changes direction. The vibrating disc fishing lure creates vibration or motion of a live bait as it moves through water, and includes a leader with a fixed loop adapted for attachment to a fishing line, the leader further being attached to a fishhook. The vibrating disc fishing lure also includes a disc on the leader positioned between the fixed loop and the fishhook, the disc having a flat front surface toward the fixed loop and a flat rear surface toward the fishhook, and having an opening that extends from the flat front surface to the flat rear surface, wherein the opening is symmetrically positioned on the disc, wherein the leader passes through the opening such that the disc is free to rotate on the leader.

Any rearward motion of the disc along the leader is stopped (directly or indirectly) by the fishhook as the vibrating disc fishing lure is pulled through water by the fishing line such that water flows against the flat front surface of the disc. The water flowing against the flat front surface of the disc when the vibrating disc fishing lure is pulled through water by the fishing line causes the disc to vibrate.

In some example embodiments, the vibrating disc fishing lure may include a first bead with a bead opening, the leader passing through the bead opening, wherein the bead is positioned between the disc and the fishhook, such that the disc contacts the bead as the vibrating disc fishing lure is pulled through the water by the fishing line. Such embodiments may be used in combination with any additional features described above or herein.

In still other example embodiments, the vibrating disc fishing lure may further include a second bead with a second bead opening, the leader passing through the second bead opening, wherein the second bead is positioned between the disc and the fixed loop, such that the disc is slidably held on the leader by the first bead and the second bead. Such embodiments may be used in combination with any additional features described above or herein.

In some example embodiments, the vibrating disc fishing lure may include a second fishhook attached to the first fishhook by a line, wherein motion is created in the first fishhook and the second fishhook when the disc vibrates. Such embodiments may be used in combination with any additional features described above or herein.

There has thus been outlined, rather broadly, some of the embodiments of the vibrating disc fishing lure in order that the detailed description thereof may be better understood, and in order that the present contribution to the art may be better appreciated. There are additional embodiments of the vibrating disc fishing lure that will be described hereinafter and that will form the subject matter of the claims appended hereto. In this respect, before explaining at least one embodiment of the vibrating disc fishing lure in detail, it is to be understood that the vibrating disc fishing lure is not limited in its application to the details of construction or to the arrangements of the components set forth in the following description or illustrated in the drawings. The vibrating disc fishing lure is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a side view of a vibrating disc fishing lure in accordance with an example embodiment.

FIG. 2 is a front view of a portion of a vibrating disc fishing lure in accordance with an example embodiment.

FIG. 3 is a section view of a disc usable with vibrating disc fishing lure in accordance with an example embodiment, taken at line 3-3 of FIG. 2.

FIG. 4 is a perspective view of a vibrating disc fishing lure in accordance with an example embodiment.

FIG. 5 is another side view of a vibrating disc fishing lure in accordance with an example embodiment.

### DETAILED DESCRIPTION

### A. Overview.

An embodiment of vibrating disc fishing lure 10 generally includes a leader 14 with a fixed loop 12 adapted for attachment to a fishing line 50, the leader 14 further being attached to a fishhook 40 using fishhook eye 42. The fishing line 50 may have a loop or snap attachment 52 for releasably attaching the lure 10 to the fishing line 50. The lure 10 also includes a disc 20 on the leader 14 positioned between the fixed loop 12 and the fishhook 40, the disc 20 having a flat front surface 22 toward the fixed loop 12 and a flat rear surface 24 toward the fishhook 40. The disc 20 also has an opening 21 that extends from the flat front surface 22 to the flat rear surface 24, wherein the opening 21 is symmetrically positioned on the disc 20 (i.e., in the center of the disc). Typically, the leader 14 passes through the opening 21 such that the disc 20 is free to rotate on the leader 14.

Any rearward motion of the disc 20 along the leader is stopped (directly or indirectly) by the fishhook 40 as the vibrating disc fishing lure 10 is pulled through water by the fishing line 50 such that water flows against the flat front surface 22 of the disc 20. The water flowing against the flat front surface 22 of the disc 20 when the vibrating disc fishing lure 10 is pulled through water by the fishing line 50 causes the disc 20 to wobble, rotate, or vibrate.

The vibrating disc fishing lure 10 may include a first bead 32 with a bead opening 33, the leader 14 passing through the bead opening 33, wherein the bead 32 is positioned between the disc 20 and the fishhook 40, such that the disc 20 contacts the bead 32 as the vibrating disc fishing lure 10 is pulled through the water by the fishing line 50.

The vibrating disc fishing lure 10 may further include a second bead 30 with a second bead opening 31, the leader 14 passing through the second bead opening 31, wherein the second bead 30 is positioned between the disc 20 and the fixed loop, such that the disc 20 is slidably held on the leader 14 by the first bead 32 and the second bead 30.

In some embodiments, the vibrating disc fishing lure 10 may include a second fishhook 44 attached to the first fishhook 40 by a line 15, which may be, for example, tied to fishhook eye 46 of the second fishhook. When the vibrating disc fishing lure 10 is used by pulling the vibrating disc fishing lure through the water, motion is created in the first fishhook 40 and the second fishhook 44 when the disc 20 vibrates due to water drag.

### B. Disc.

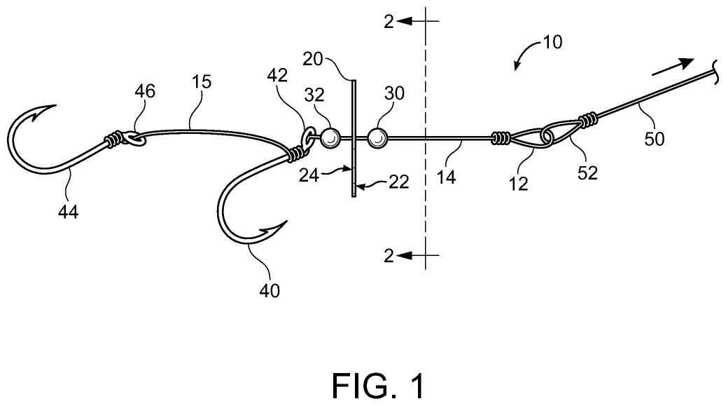

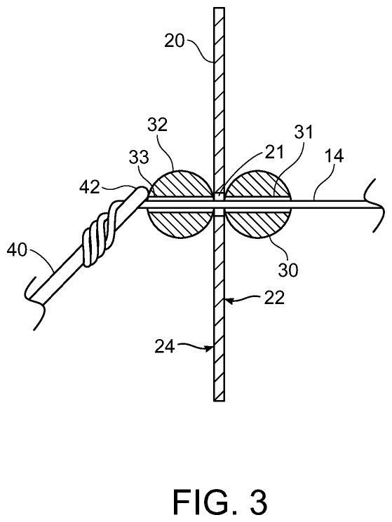

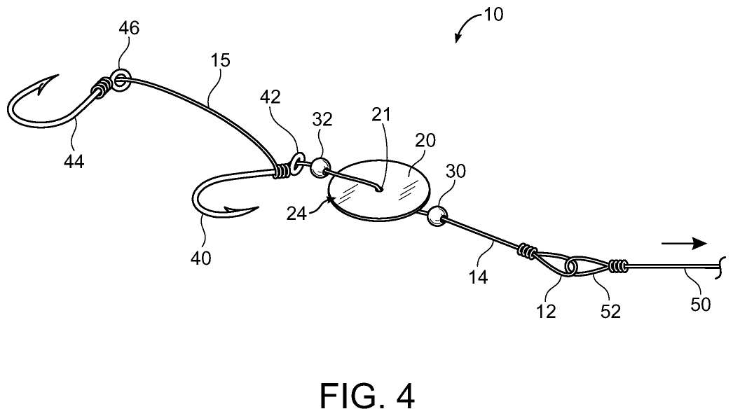

As shown in FIGS. 1-6, the vibrating disc fishing lure 10 includes a disc 20 that is designed to be pulled through the water such that the water acting on the flat front surface 22 and the flat rear surface 24 create drag forces that result in wobble or rotation of the disc 20, and also motion on one or more fishhooks such as 40 and 44 (which may comprise a crawler harness) that are part of the vibrating disc fishing lure 10. As best shown in FIGS. 3 and 4, the flat rear surface 24 tapers to the position where it meets the flat front surface 22, which contributes to the forces exerted on the disc 20 by the water, and allows for lower resistance to rotation or wobble of the disc 20.

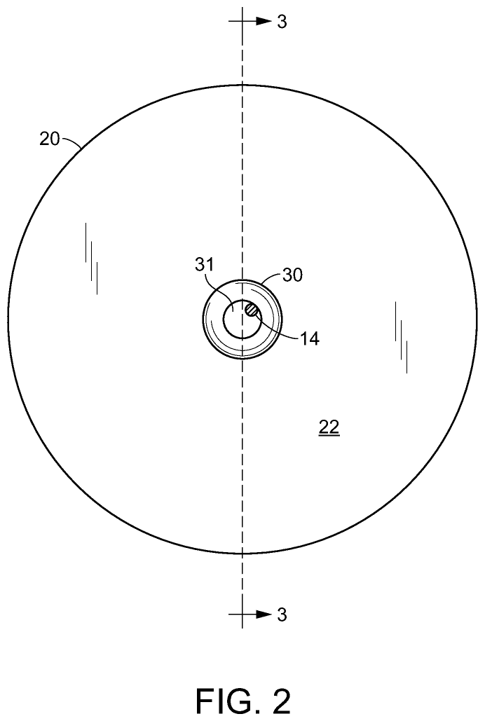

As perhaps best shown in FIGS. 2-4, the disc includes an opening 21 through which leader 14 passes. The opening 21 is typically located symmetrically on the disc 20. When the vibrating disc fishing lure 10 is being pulled through the water, the disc vibrates, wobbles and rotates or moves away from a “straight” position, as shown by position 60 in FIG. 6.

As mentioned, and as shown best in FIGS. 1 and 4-6, the leader 14 of the vibrating disc fishing lure 10 passes through the opening 21 of disc 20. The front end of the leader 14 can include a fixed loop 12 for attachment to a line loop 52 or other attachment (such as a snap swivel), on fishing line 50. The other end of the leader 14, spaced apart from fixed loop 12, can be tied or otherwise attached to the first fishhook 40. On either side of disc 20, there may be a first bead 32 and a second bead 30. The first bead 32 has an opening 33 which the leader 14 also passes through, and similarly, the second bead 30 has an opening 21 which the leader passes through. The beads may protect the disc 20 from being damaged by the leader, the fishing line 50, or by parts of the fishhooks, such as the fishhook eye 42 of fishhook 40. The beads may be threaded onto the leader 14 so that they slide freely on it, or they may be secured to it such that their motion along the leader is more limited.

In addition to a single fishhook 40, the vibrating disc fishing lure 10 may include a second fishhook 44, typically connected to the first fishhook 40 by line 15, so that larger bait items may be used with the vibrating disc fishing lure 10, as shown in FIGS. 1, 4, and 5. This “harness” may be formed by the leader passing through the disc 20 and beads 30, 32, being tied to fishhook eye 42 of fishhook 40, then being tied to fishhook eye 46 of fishhook 44. The noted lines may thus be formed from one continuous line, wire, etc., or may be made from separate lines or pieces tied at appropriate places, such as the fishhook eyes 42 and 46.

### C. Operation of Preferred Embodiment.

In use, the vibrating disc fishing lure 10 is pulled through the water or retrieved by a user reeling in a fishing line 50 or trolling. In doing so, the vibrating disc fishing lure 10 is retrieved or pulled through the water in the direction indicated by the arrow adjacent fishing line 50 in FIGS. 1, 4, and 5. As the vibrating disc fishing lure 10 moves through the water, the water presents resistance to the vibrating disc fishing lure, and especially to the flat front surface 22 of disc 20.

Any rearward motion of the disc 20 along the leader 14 is stopped (directly or indirectly) by the first fishhook 40 as the vibrating disc fishing lure 10 is pulled through the water by the fishing line 50 such that water flows against the flat front surface 22 of the disc. The water flowing against the flat front surface 22 of the disc 20 when the vibrating disc fishing lure 10 is pulled through water by the fishing line 50 causes the disc 20 to vibrate, wobble or rotate.

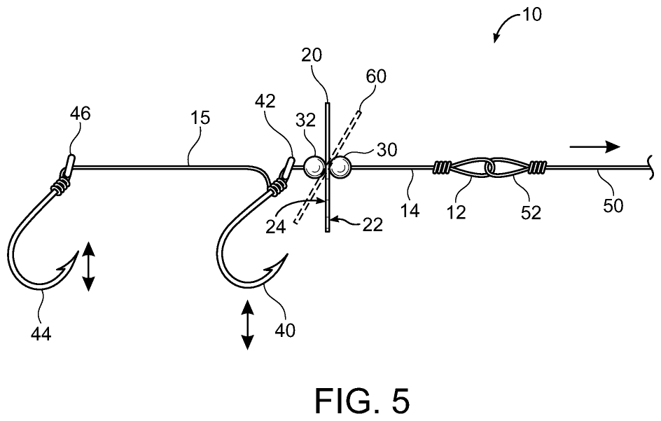

The water resistance against the flat front surface 22 of disc 20 generally results in unpredictable, multi-directional motion, such as vibration, wobble or rotation, which is transferred to the live bait (not shown) on fishhooks 40 and 44, (as indicated by the arrows in FIG. 5, for example) since the fishhooks are attached to the same leader as disc 20. The arrows do not necessarily represent the only motion or vibration induced on fishhooks 40 and 44, as the disc 20 can cause irregular motion, wobble, rotation, and vibration of the fishhooks and any bait that is on them. Thus, the vibrating disc fishing lure 10 adds “action” and flash to live bait on the vibrating disc fishing lure 10.

In FIG. 5, a displaced alternate position of disc 20 is shown, represented by reference numeral 60. This represents a transient position, which is in practice irregular, as mentioned above. When the vibrating disc fishing lure 10 is retrieved or moved through the water, the vibrating disc fishing lure 10 will vibrate and wobble. The disc 20 can freely rotate about leader 14, which passes through the opening 21.

As shown generally in the figures, the vibrating disc fishing lure 10 can include a fixed loop 12 for attachment to a fishing line 50, such as by a loop 52 in the end of the line 50 (a snap swivel may also be used). The disc 20 is generally in the form of a rigid, flat disc, and beads 30, 32 may be made of a relatively hard material to protect and disc 20 from damage, especially from the line of leader 14, or knots that may damage the disc 20 at opening 21. The beads may also protect the leader 14 from the edges of the opening 21 of disc 20.

Unless otherwise defined, all technical and scientific terms used herein have the same meaning as commonly understood by one of ordinary skill in the art to which this invention belongs. Although methods and materials similar to or equivalent to those described herein can be used in the practice or testing of the vibrating disc fishing lure, suitable methods and materials are described above. All publications, patent applications, patents, and other references mentioned herein are incorporated by reference in their entirety to the extent allowed by applicable law and regulations. The vibrating disc fishing lure 10 may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A vibrating fishing lure that creates action of a live bait as the lure moves through water, comprising:
a leader with a fixed loop adapted for attachment to a fishing line, the leader further being attached to a fishhook; and
a disc on the leader positioned between the fixed loop and the fishhook, the disc having a flat front surface toward the fixed loop and a flat rear surface toward the fishhook, and having an opening that extends from the flat front surface to the flat rear surface, wherein the leader passes through the opening such that the disc is free to rotate on the leader;
wherein a motion of the disc along the leader is stopped by the fishhook as the vibrating fishing lure is pulled through water by the fishing line such that water flows against the flat front surface of the disc; and
wherein water flowing against the flat front surface of the disc when the vibrating fishing lure is pulled through water by the fishing line causes the disc to vibrate.

2. The vibrating fishing lure of claim 1, further comprising a bead with a bead opening, the leader passing through the bead opening, wherein the bead is positioned between the disc and the fishhook, such that the disc contacts the bead as the vibrating fishing lure is pulled through water by the fishing line.

3. The vibrating fishing lure of claim 2, wherein the bead comprises a first bead, the vibrating fishing lure further comprising a second bead with a second bead opening, the leader passing through the second bead opening, wherein the second bead is positioned between the disc and the fixed loop, such that the disc is slidably held on the leader by the first bead and the second bead.

4. The vibrating fishing lure of claim 1, wherein the opening is in the center of the disc.

5. The vibrating fishing lure of claim 4, further comprising a bead with a bead opening, the leader passing through the bead opening, wherein the bead is positioned between the disc and the fishhook, such that the disc contacts the bead as the vibrating fishing lure is pulled through water by the fishing line.

6. The vibrating fishing lure of claim 5, wherein the bead comprises a first bead, the vibrating fishing lure further comprising a second bead with a second bead opening, the leader passing through the second bead opening, wherein the second bead is positioned between the disc and the fixed loop such that the disc is slidably held on the leader by the first bead and the second bead.

7. The vibrating fishing lure of claim 1, wherein the fishhook comprises a first fishhook, the vibrating fishing lure further comprising a second fishhook attached to the first fishhook by a line, wherein motion is created in the first fishhook and the second fishhook when the disc vibrates.

8. The vibrating fishing lure of claim 7, wherein the opening is in the center of the disc.

9. The vibrating fishing lure of claim 7, further comprising a bead with a bead opening, the leader passing through the bead opening, wherein the bead is positioned between the disc and the fishhook, such that the disc contacts the bead as the vibrating fishing lure is pulled through water by the fishing line.

10. The vibrating fishing lure of claim 9, wherein the bead comprises a first bead, the vibrating fishing lure further comprising a second bead with a second bead opening, the leader passing through the second bead opening, wherein the second bead is positioned between the disc and the fixed loop, such that the disc is slidably held on the leader by the first bead and the second bead.

11. A vibrating fishing lure that creates wobble or motion of a live bait as it moves through water, comprising:
a leader with a fixed loop adapted for attachment to a fishing line, the leader further being attached to a first fishhook;
a disc on the leader positioned between the fixed loop and the fishhook, the disc having a flat front surface toward the fixed loop and a flat rear surface toward the first fishhook, and having an opening that extends from the flat front surface to the flat rear surface, wherein the leader passes through the opening such that the disc is free to rotate on the leader;
wherein the opening is in the center of the disc;
a first bead with a first bead opening, the leader passing through the first bead opening, wherein the first bead is positioned between the disc and the first fishhook, such that the disc contacts the first bead as the vibrating fishing lure is pulled through water by the fishing line;
a second bead with a second bead opening, the leader passing through the second bead opening, wherein the second bead is positioned between the disc and the fixed loop, such that the disc is slidably held on the leader by the first bead and the second bead; and
a second fishhook attached to the first fishhook by a line;
wherein a motion of the disc along the leader is stopped by the first bead as the vibrating fishing lure is pulled through water by the fishing line such that water flows against the flat front surface of the disc;
wherein water flowing against the flat front surface of the disc when the vibrating fishing lure is pulled through water by the fishing line causes the disc to vibrate; and
wherein motion is created in the first fishhook and the second fishhook when the disc vibrates.
